(19) United States
(12) Patent Application Publication
(10) Pub. No.: US 2013/0105089 A1
(43) Pub. Date: May 2, 2013

(54) METHOD FOR SEPARATING SUBSTRATE ASSEMBLY

(71) Applicant: Industrial Technology Research Institute, Hsinchu (TW)

(72) Inventors: Ru-De Chen, Taichung City (TW); Hsin-Yun Hsu, Hsinchu County (TW)

(73) Assignee: INDUSTRIAL TECHNOLOGY RESEARCH INSTITUTE, Hsinchu (TW)

(21) Appl. No.: 13/661,049

(22) Filed: Oct. 26, 2012

Related U.S. Application Data
(60) Provisional application No. 61/552,574, filed on Oct. 28, 2011.

(30) Foreign Application Priority Data
Oct. 24, 2012 (TW) 101139304

(51) Int. Cl. B32B 38/10; B32B 33/00; B32B 3/24

(52) U.S. Cl. 156/701; 428/138

(57) ABSTRACT

A method for separating a substrate assembly is provided. A substrate assembly including a first substrate and a second substrate is provided first. The second substrate has at least a through hole. The first substrate and the second substrate are adhered together so that the through hole exposes the first substrate. A fluid is then injected between the first substrate and the second substrate through the through hole so as to separate the first substrate from the second substrate.

### CROSS-REFERENCE TO RELATED APPLICATION

This application claims the priority benefits of U.S. provisional application Ser. No. 61/552,574, filed on Oct. 28, 2011 and Taiwan application serial no. 101139304, filed on Oct. 24, 2012. The entirety of each of the above-mentioned patent applications is hereby incorporated by reference herein and made a part of this specification.

### TECHNICAL FIELD

The technical field relates to a method for separating an object, and more particularly to, a method for separating a substrate assembly.

### BACKGROUND

Since an electronic device is required to have characteristics of being thin, flexible, impact-resistant, highly secured and easy to carry, the use of a flexible substrate or a thin substrate to manufacture the electronic device has become a trend of future development. The manufacturing of electronic components on such substrate may generally be divided into two methods: one of the methods is to directly manufacture the electronic components on the flexible or thin substrate, and the other method is to transfer the electronic components onto the flexible or thin substrate in an indirect manufacture process.

If wanting to directly manufacture the electronic components on the flexible or thin substrate, the flexible or thin substrate is required to be firstly adhered onto a bearing substrate with more rigid mechanical nature, so as to become suitable for being transmitted by traditional rollers and mechanical arms. Later on, the required electronics components are then manufactured on the flexible or thin substrate. After the components are being completed, the flexible or thin substrate and the electronics components formed thereon must be separated from the rigid bearing substrate. The flexible or thin substrate is often tightly adhered on the rigid bearing substrate via an adhesion layer, so as to avoid an occurrence of substrate displacement during the manufacturing process of the electronic device; however, this also makes a complete separation of the flexible or thin substrate from the rigid bearing substrate to be difficult.

### SUMMARY

The disclosure provides a simple and low cost method for separating a substrate assembly, and a substrate assembly thereof, which allows a substrate with bearing function to be reusable.

The disclosure provides a method for separating a substrate assembly. Firstly, a substrate assembly is provided, and the substrate assembly includes a first substrate and a second substrate. The second substrate has at least one through hole. When the first substrate and the second substrate are adhered together, the through hole exposes the first substrate. Next, a fluid is injected between the first substrate and the second substrate through the through hole so as to separate the first substrate from the second substrate.

The disclosure provides a substrate assembly. The substrate assembly includes a first substrate and a second substrate. The second substrate is tightly adhered to the first substrate, and the second substrate has at least one through hole, wherein the through hole exposes the first substrate and is connected to the outside.

According to the foregoing, embodiments of the disclosure uses the fluid to separate the two substrates in the substrate assembly without a use of heating or chemical agent, thereby reducing damages to the substrates and the components on the substrates due to the use of heating or chemical agent. Moreover, after the substrates are being separated by the method disclosed in this disclosure, the second substrate with bearing function may be reused and thus is helpful in saving costs.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A and FIG. 1B are schematic diagrams illustrating a method for manufacturing a substrate assembly according to an exemplary embodiment.

FIG. 1C and FIG. 1D are cross-sectional diagrams respectively illustrating the substrate assembly in FIG. 1B along a profile line A-A′ and a profile line B-B′.

FIG. 1E to FIG. 1G are schematic diagrams illustrating a method for separating a substrate assembly according to an exemplary embodiment.

FIG. 2 to FIG. 5 are top view diagrams schematically illustrating several second substrates according to several exemplary embodiments.

FIG. 6A to FIG. 6C are schematic diagrams illustrating a method for separating a substrate assembly according to an exemplary embodiment.

FIG. 7A and FIG. 7B are schematic diagrams illustrating a method for separating a substrate assembly substrate according to another exemplary embodiment.

FIG. 8A and FIG. 8B are schematic diagrams illustrating a method for separating a substrate assembly substrate according to yet another exemplary embodiment.

### DETAILED DESCRIPTION OF DISCLOSED EMBODIMENTS

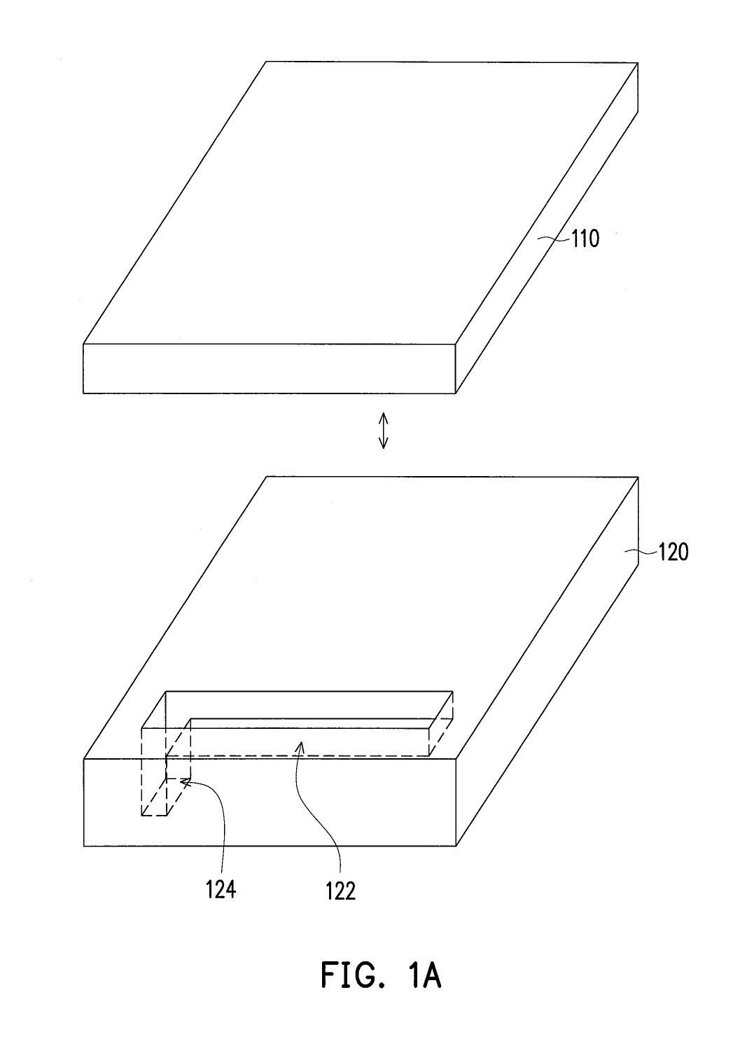

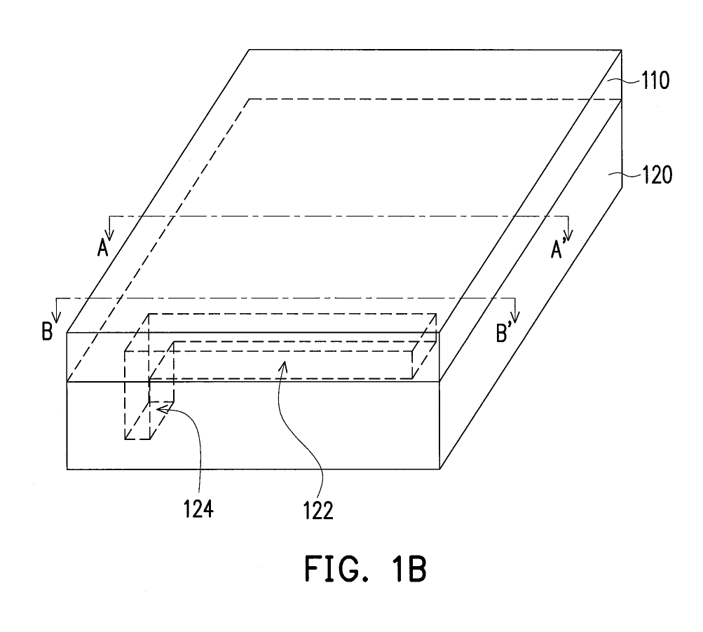

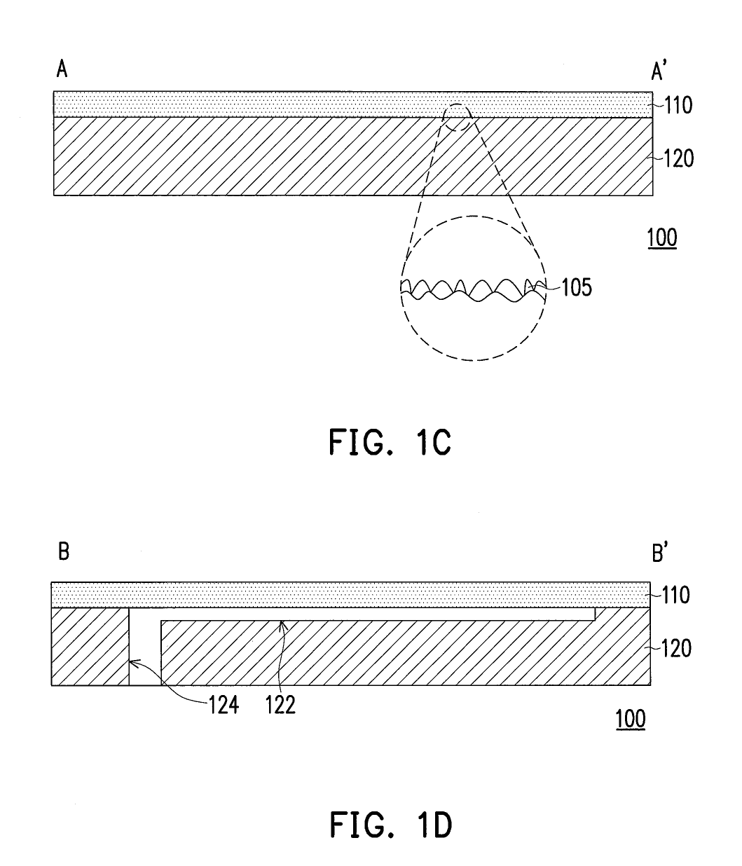

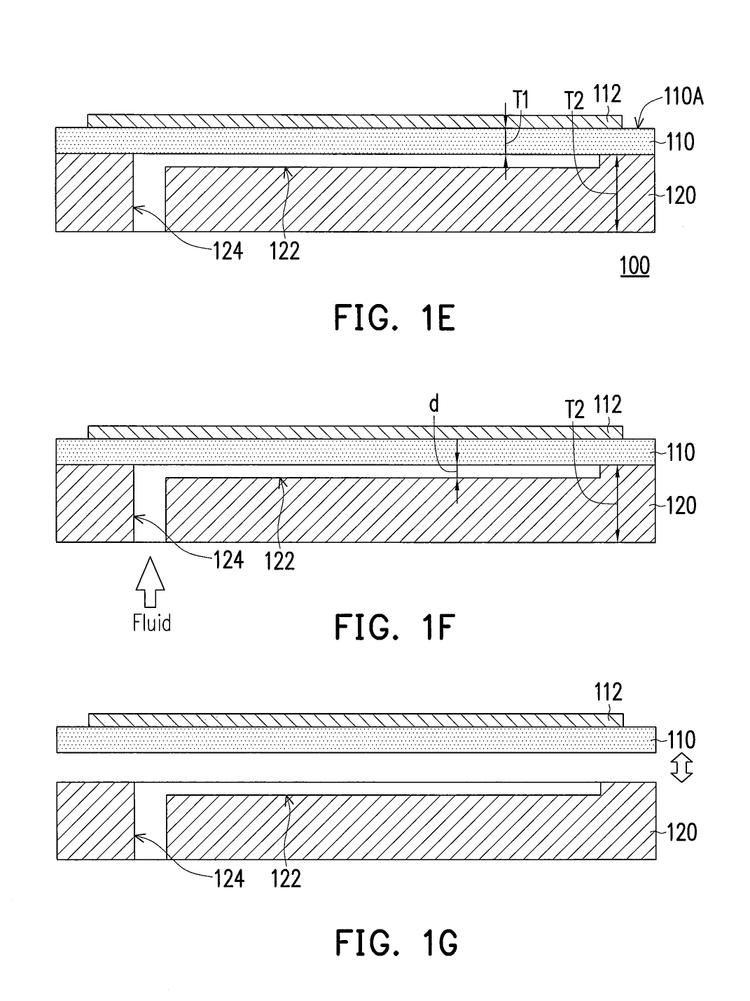

FIG. 1A and FIG. 1B are schematic diagrams illustrating a method for manufacturing a substrate assembly according to an exemplary embodiment. As shown in FIG. 1A, a first substrate 110 and a second substrate 120 are provided. In the present embodiment, the first substrate 110 is adhered onto the second substrate 120, so that the first substrate 110 and the second substrate 120 are closely in contact with each other and constituted the substrate assembly 100, as shown in FIG. 1B.

The first substrate 110 is a thin substrate, and may be a substrate of silicon, ceramic or glass material, or a high temperature resistant soft substrate of plastic or metal material, and an average surface roughness thereof is less than 300 nm. A thickness of the first substrate 110 is approximately between 0.01 mm to 0.2 mm, or less than 0.3 mm, but the disclosure is not limited thereto.

The second substrate 120 may be a rigid or soft substrate of silicon, glass, metal, plastic, or Teflon material, and an average surface roughness thereof is less than 300 nm. A thickness of the second substrate 120 is approximately between 0.2 mm to 3.0 mm, and the second substrate 120 is adapted to support or bear the first substrate 110, so as to perform a treatment or a process of the first substrate 110.

Specifically, the second substrate 120 has a recessed structure 122 and a through hole 124, wherein the through hole 124 is connected with the recessed structure 122. Therefore, cross-sections of the substrate assembly 100 along a profile line A-A′ and a profile line B-B′ may be as shown in FIG. 1C and FIG. 1D. Referring to FIG. 1C, the substrate assembly 100 forms enclosed spaces 105 between the first substrate 110 and the second substrate 120 via vacuuming, and the enclosed spaces 105 have obvious air pressure differences with the external environment, and therefore an external gas pressure causes the first substrate 110 and the second substrate 120 to be tightly adhered. When an adhesion between the first substrate 110 and the second substrate 120 is tightly enough, van der Waals force and capillary attraction may further be acting between the two, thus further strengthening the adhesion between the two, so that the first substrate 110 and the second substrate 120 are maintained in a stable adhering state in order to perform subsequent device manufacturing processes, such as in fields of a liquid crystal display (LCD) panel, an integrated circuit (IC), a light emitting diode (LED), and an organic light emitting diode (OLED). In the present embodiment, the enclosed spaces 105 may be gaps between the rough surface structures of the first substrate 110 and the second substrate 120, and a degree of vacuum in the enclosed spaces 105 is, for example, less than 1 torr.

Moreover, according to FIG. 1D, as corresponded to locations of the recessed structure 122 and the through hole 124, the first substrate 110 and second substrate 120 are not in contact with each other. In the present embodiment, the subsequent manufacturing processes of the first substrate 110 are, for example, performed under a condition that the second substrate 120 remains bearing the first substrate 110. Furthermore, after the subsequent manufacturing processes are completed, the first substrate 110 and the second substrate 120 in the substrate assembly 100, for example, are being separated so as to complete the required device. In order to clearly explain the remaining steps of the present embodiment, the cross-section of the substrate assembly 100 illustrated FIG. 1D, in the following below, is taken as an example for description purposes.

FIG. 1E to FIG. 1G are schematic diagrams illustrating a method for separating a substrate assembly according to an exemplary embodiment. Referring to FIG. 1E, in the present embodiment, the pre-determined to be separated substrate assembly 100 includes the first substrate 110 and the second substrate 120 that are adhered together. The first substrate 110 may have an element layer 112 formed on a surface 110A away from the second substrate 120. In an embodiment, the element layer 112 may be an active element layer, a color filter element layer, a touch element layer, or a sensing element layer. Therefore, the element layer 112 may be constituted of at least one insulating material layer, at least one conductive material layer or a combination thereof. Specifically, a manufacturing method of the element layer 112 includes a least one of a film formation process and a patterning process, wherein the film formation process includes deposition, coating, and sputtering processes, and the patterning process includes lithography etching and laser machining processes.

In the present embodiment, a thickness T1 of the first substrate 110 is approximately less than 0.3 mm, and may provide a flexible nature or facilitate in a device thinning. However, a mechanical strength of the thinned first substrate 110 is not high, the element layer 112 may be damaged in a manufacturing process thereof or, the thinned first substrate 110 has a characteristics of flexibility, so that in the manufacturing process of the element layer 112, phenomena such as unable to transfer by a process machine, an alignment offset, and an incomplete film formation are prone to occur. Therefore, before manufacturing the element layer 112 on the first substrate 110, the first substrate 110 may firstly be adhered on the second substrate 120, wherein a thickness T2 of the second substrate 120 may be greater than the thickness T1 of the first substrate 110, and the second substrate 120 may be a rigid substrate. Now, the second substrate 120 with a stronger mechanical strength may be adapted to bear the first substrate 110, thus avoiding the first substrate 110 from being damaged in the manufacturing process of the element layer 112.

The second substrate 120 and the first substrate 110 may be adhered to each other via Van der Waals force adhesion. In addition, a size of the first substrate 110 may be smaller than a size of the second substrate 120, so that the second substrate 120 may bear and support the entire first substrate 110. Noteworthily, after the manufacturing of the element layer 112 is completed, the first substrate 110 has to be separated from the second substrate 120 so that the first substrate 110 and the element layer 112 may constitute the required device. The separation of the first substrate 110 and the second substrate 120 is further described in the following.

It can be known from FIG. 1E, the second substrate 120 has the recessed structure 122 and the through hole 124, wherein a depth d of the recessed structure 122 is smaller than the thickness T2 of the second substrate 12. In an embodiment, when the thickness T2 of the second substrate 120 is 1.1 mm, the depth d of the recessed structure 122 may be 0.4 mm, but not limited thereto. Herein, the recessed structure 122, in terms of a width design thereof, is unable to cause a negative impact on maintaining the first substrate 110 and the second substrate 120 in a state of tightly adhering to each other. Under a condition that the first substrate 110 and the second substrate 120 are adhered together, the recessed structure 120 is sandwiched between the first substrate 110 and the second substrate 120. Namely, the recessed structure 122 is disposed at a side of the second substrate 120 that is pre-determined to be adhered with the first substrate 110. In addition, before the first substrate 110 and second substrate 120 are adhered together, the recessed structure 122 is exposed to the outside. Moreover, the through hole 124 is connected to the recessed structure 122, and when the first substrate 110 and the second substrate 120 are adhered together, the recessed structure 122 may be connect to the outside through the through hole 124. In other words, one end of the through hole 124 is connected to the recessed structure 122 and the other end is connected to the external.

Next, referring to FIG. 1F, in the present embodiment, since the recessed structure 122 may connect to the external through the through hole 124, a fluid may be injected into the recessed structure 122 through the through hole 124. Herein, the fluid may be liquid, gas or a combination thereof. The fluid injected into the recessed structure 122 applies a stress to the first substrate 110 and the second substrate 120, and as this stress becomes greater than the adhesion between the first substrate 110 and the second substrate 120, the first substrate 110 is then may be separated from the second substrate 120, as shown in FIG. 1G.

Specifically, in the process of separation, when the fluid is injected through the through hole 124, the fluid may partially separate the first substrate 110 and the second substrate 120. Afterwards, an object may further be inserted from a location of partial separation at the adhering surfaces of the first substrate and the second substrate, so as to completely separate the first substrate 110 from the second substrate 120. In an embodiment, the object may include a thread or sheet, such as a blade.

In the present embodiment, by using a fluid injection to separate the first substrate 110 from the second substrate 120, a heating step or a chemical agent is not required to be adopted so as to separate the first substrate 110 and the second substrate 120 from each other. Therefore, the first substrate 110 and the element layer 112 are not going to be damaged due to heat required in a separation step, and are also not going to be deteriorated due to additional use of chemical agent. Hence, the first substrate 110, after being separated from the second substrate 120, may still retain a favorable nature, and may facilitate in improving production yields of the first substrate 110 and the element layer 112. In addition, the first substrate 110 and the second substrate 120 are neither required to be in a high temperature environment nor in a contact with the chemical agent during the separation process. As such, the second substrate 120 may also retain its original features, and may be used repetitively, so that the overall production costs are lowered and the overall manufacturing processes are more simplified. Particularly, when adopting the method illustrated in the present embodiment to separate the first substrate 110 from the second substrate 120 when the first substrate 110 is adhered onto the second substrate 120 via vacuuming, no adhesive is to be remained on the second substrate 120, and thus the second substrate 120 may directly be used repetitively.

FIG. 1E to FIG. 1G only schematically illustrate the cross-sectional structures of the second substrate 120 to clearly demonstrate the separation method described in the present embodiment. However, the disclosure is not intended to particularly limit an appearance and a distribution location of the recessed structure 122 in the second substrate 120. The following below provides exemplary descriptions for designs of the second substrate 120, but the disclosure is not limited to these designs.

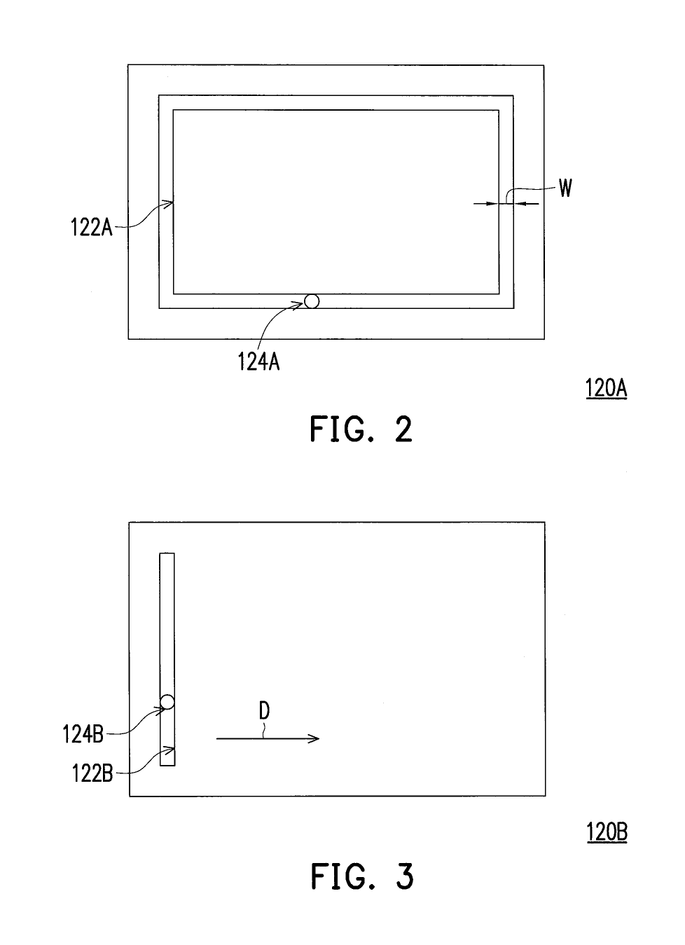

FIG. 2 to FIG. 5 are top view diagrams schematically illustrating several second substrates according to several exemplary embodiments. Referring to FIG. 2, a second substrate 120A has a recessed structure 122A constituting a frame-shaped pattern, and a through hole 124A may be connected to the recessed structure 122A and located in the frame-shaped pattern. The recessed structure 122A constituting the frame-shaped pattern, when being applied to the separation method of the substrate assembly illustrated in FIG. 1E to FIG. 1G, may provide a stress of frame-shaped distribution so that a stress distribution subjected to the first substrate and the second substrate are more uniform. Herein, a width W of the recessed structure 120A may be set according to different requirements, wherein the width W in an embodiment may be 2 mm, but is not limited thereto.

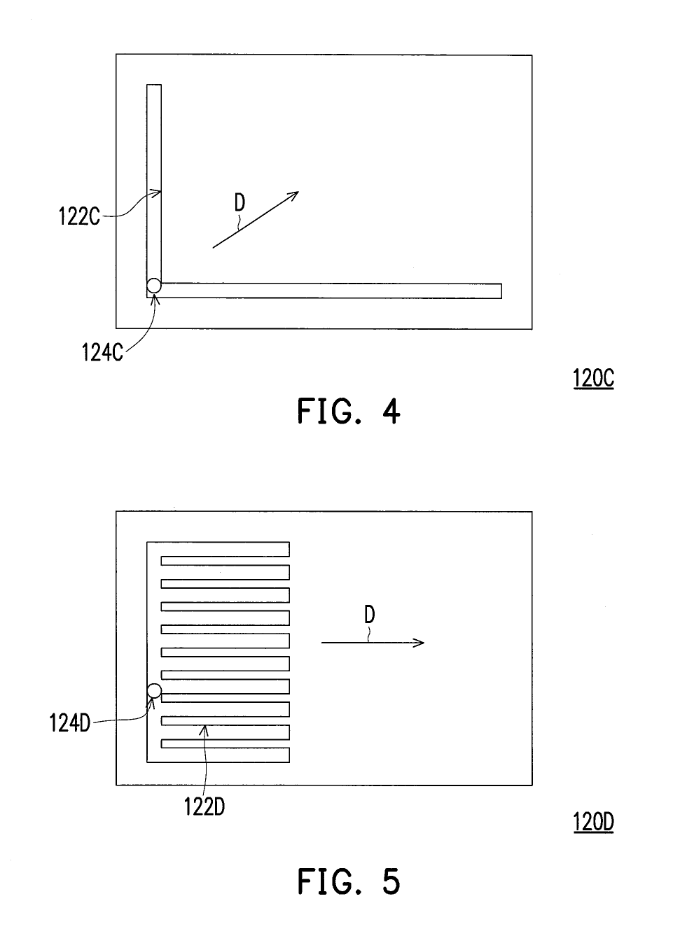

Moreover, as shown in FIG. 3, a second substrate 120B may have a linear recessed structure 122B, and a through hole 124B is connected to the linear recessed structure 122B. When the second substrate 120B is a polygon, the linear recessed structure 122B may be near to one side of second substrate 120B, or may selectively be disposed in the center of the second substrate 120B. In FIG. 4, the second substrate 120C may have a L-shaped recessed structure 122C, and a through hole 124C connected to the L-shaped recessed structure 122C may be disposed at anywhere on the L-shaped pattern.

In FIG. 5, a recessed structure 122D of a second substrate 120D may have a plurality of linear portions, and these linear portions may be connected together to constitute a comb-like pattern. When the second substrate 120D is a polygon, the recessed structure 122D may be disposed near to a side of the second substrate 120D, and extend towards the center of the second substrate 120D from this side. Namely, an extending direction of the linear portions of the recessed structure 122D may intercept with the sides nearby. As a result, the recessed structure 122D, when being injected with the fluid, may provide a stress applied along a direction D so as to separate the substrate assembly along the direction D. Now, the separation of the substrate assembly may have a specific directivity. Certainly, the pattern designs mentioned in FIG. 3 and FIG. 4 are also helpful in providing specific directivity to the separation of the substrate assembly. In terms of the design in FIG. 3, the separation direction D of the substrate assembly 120B, for example, begins from the left of the diagram to the right; and in terms of the design in FIG. 4, the separation direction D of the substrate assembly 120C, for example, begins from the bottom-left of the diagram to the upper-right.

Other than the above-mentioned designs, the recessed structures 122, 122A to 122D may also selectively have a variety of appearances, such as wavy-shaped, circular, curvy-shaped, and irregular-shaped; and the through holes 124, 124A to 124D connected to the recessed structure 122, 122A to 122D may be in pluralities instead of one. For example, in other embodiments, the recessed structure may constitute at least two independent patterns that are unconnected with each other, and different patterns of the recessed structure are connected to different through holes. Now, fluid injection timings and stresses of the injected fluids of the different through holes may be inconsistent so as to control a separation direction or a separation rate of the first substrate and the second substrate.

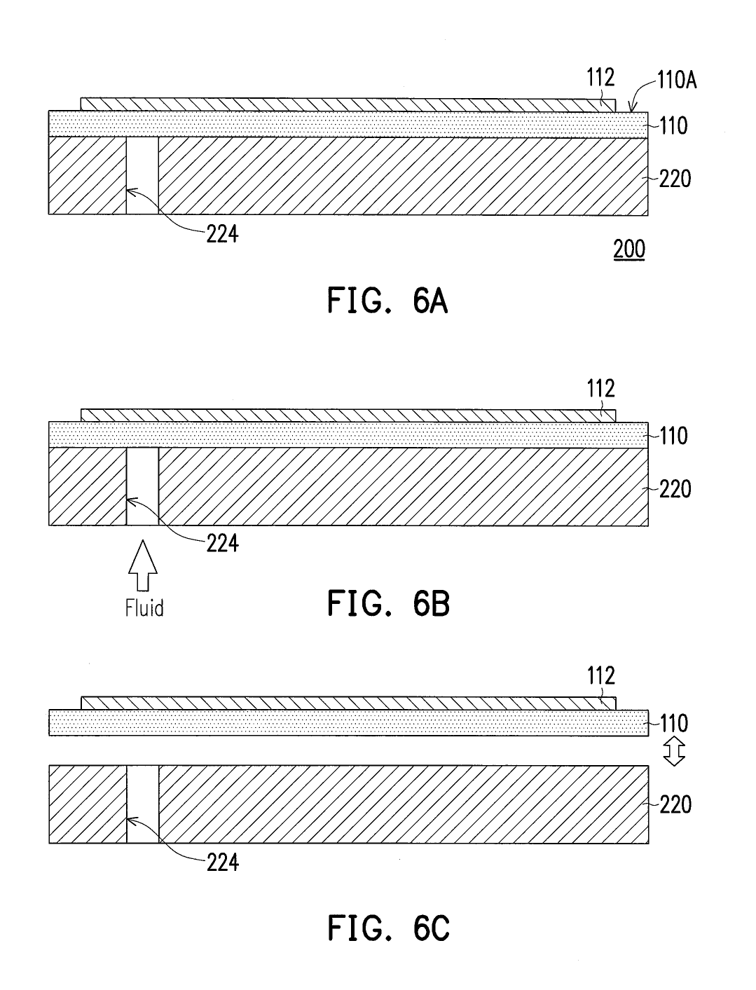

Other than the above-mentioned embodiment, FIG. 6A to FIG. 6C are schematic diagrams illustrating a method for separating a substrate assembly according to an exemplary embodiment. Referring to FIG. 6A, a pre-determined to be separated substrate assembly 200 in the present embodiment includes a first substrate 110 and a second substrate 220 that are adhered together. In the present embodiment, a thickness T of the first substrate 110 is approximately less than 0.3 mm, and thus may provide a flexible nature or facilitate in a device thinning. Specifically, the first substrate 110 of the present embodiment is generally similar to the first substrate 110 of the previous embodiment, and therefore, details on the material and the characteristics of the first substrate 110 may be referred to the previous embodiment.

It can be known from FIG. 6A, a main difference between the second substrate 220 and the second substrate 120 is that the second substrate 220 in the present embodiment has a through hole 224 without the recessed structure 122 in the previous embodiment. Under a condition that the first substrate 110 and the second substrate 220 are adhered together, the through hole 224 exposes the first substrate 110 and is connected to the external.

Next, referring to FIG. 6B, a fluid may be injected between the first substrate 110 and the second substrate 220 through the through hole 224. Herein, the fluid may be liquid, gas or a combination thereof. The injected fluid applies a stress to the first substrate 110 and the second substrate 220, and as this stress is greater than an adhesion between the first substrate 110 and the second substrate 220, the first substrate 110 is then be separated from the second substrate 220, as shown in FIG. 6C.

In the present embodiment, by using a fluid injection to separate the first substrate 110 from the second substrate 220, a heating step or a chemical agent is not required to be adopted so as to separate the first substrate 110 and the second substrate 220 from each other. Therefore, the first substrate 110 and the element layer 112 are not going to be damaged due to heat required in a separation step, and are also not going to be deteriorated due to additional use of chemical agent. Hence, production yields of the first substrate 110 and the element layer 112 may be improved. In addition, the first substrate 110 and the second substrate 220 are neither required to be in a high temperature environment nor in a contact with the chemical agent during the separation process. As such, the second substrate 220 may also retain its original features, and may be used repetitively, so that the overall production costs are lowered and the overall manufacturing processes are more simplified.

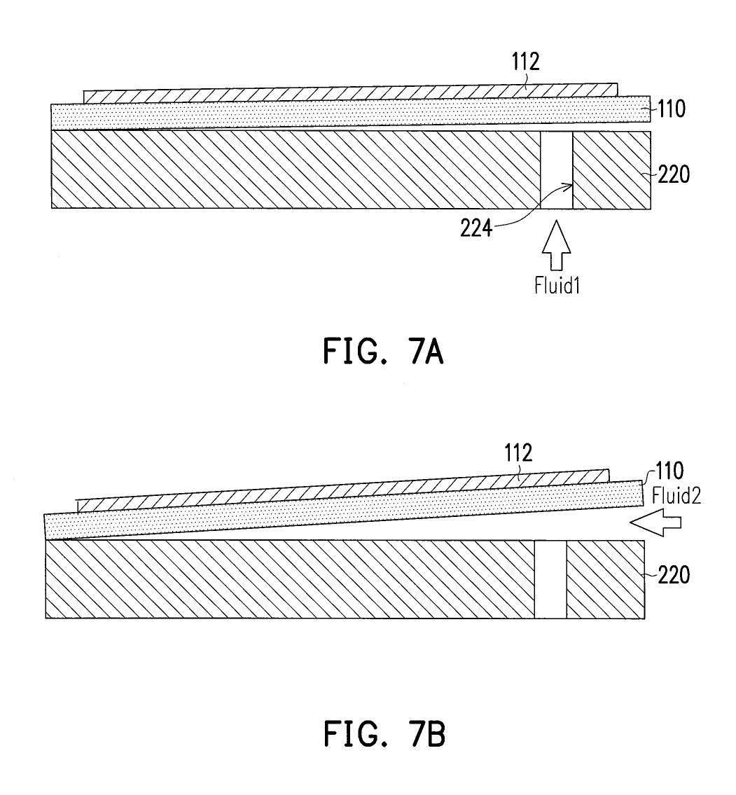

Noteworthily, the separation method of the first substrate 110 and the second substrate 220 is not limited thereto. In other embodiments, FIG. 7A and FIG. 7B are schematic diagrams illustrating a method for separating a substrate assembly substrate according to another exemplary embodiment. The method described in the present embodiment may be used to separate the substrate assembly 200 illustrated in FIG. 6A, and therefore similar components in the two embodiments are labelled with the same notations. Referring to FIG. 7A, in order to separate the first substrate 110 from the second substrate 220, in the present embodiment, a fluid 1 is firstly injected into the through hole 224. Now, the fluid 1 partially separates the first substrate 110 from the second substrate 220. Next, referring to FIG. 7B, another fluid is being injected at a location of partial separation between the first substrate 110 and the second substrate 220, namely a fluid 2, so as to completely separate the first substrate 110 from the second substrate 220. In overall, in the disclosure, the fluid is not limited to only be injected through the through hole 224, such that the fluid may still facilitate the separation of the first substrate 110 and the second substrate 220 as long as being injected between the first substrate 110 and the second substrate 220. Moreover, in the present embodiment, the fluid 1 and the fluid 2 may be a same fluid or different fluids, and they may each be liquid, gas, or a combination of liquid and gas.

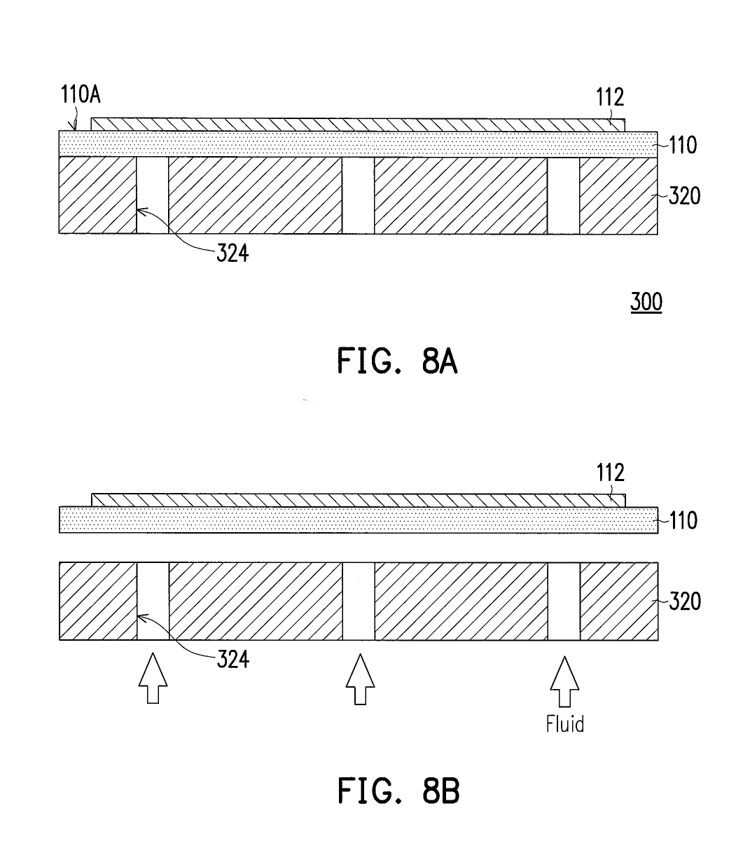

FIG. 8A and FIG. 8B are schematic diagrams illustrating a method for separating a substrate assembly substrate according to yet another exemplary embodiment. Referring to FIG. 8A, the method for separating a substrate assembly in the present embodiment is substantially similar to the method illustrated in FIG. 6A to FIG. 6C, wherein a substrate assembly 300 includes a first substrate 110 and a second substrate 320 that are adhered together, and an element layer 112 is selectively disposed on a surface 110A of the first substrate 110 away from the second substrate 320. Specifically, in the present embodiment, the second substrate 320 has a plurality of through holes 224.

Next, referring to FIG. 8B, in order to separate the first substrate 110 from the second substrate 320, in the present embodiment, a fluid is being injected into the through holes 324 to enable the fluid to apply a stress between the first substrate 110 and the second substrate 320 to separate the first substrate 110 from the second substrate 320.

In summary, after the thinned first substrate of the disclosure is adhered to the second substrate with bearing function, the first substrate is separated from the second substrate by injecting the fluid into the through hole structures on the second substrate. As a result, the separation of the substrates requires neither a use of heating nor an additional use of chemical agent, and thus is helpful in simplifying the separation of the substrate assembly, and may also facilitate in avoiding substrates from being damaged in the process of separating the substrate assembly. Moreover, after the separation, the second substrate with bearing function may be used repetitively and thus is helpful in saving the production costs.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A substrate assembly comprising:
a first substrate comprising a first surface; and
a second substrate comprising a second surface and a third surface, the second surface of the second substrate directly connected to the first surface of the first substrate, and the second substrate having at least one through hole, wherein the at least one through hole extends from the second surface to the third surface and exposes the first surface of the first substrate;
wherein the first substrate and the second substrate comprise a plurality of enclosed spaces therebetween, and a degree of vacuum of the enclosed spaces is less than 1 torr.

2. The substrate assembly as recited in claim 1, wherein the second surface of the second substrate further comprises at least one recessed structure, the recessed structure connects to the third surface of the second substrate through the through hole.

3. The substrate assembly as recited in claim 2, wherein when overlooking the second surface of the second substrate, the recessed structure is frame-shaped.

4. The substrate assembly as recited in claim 2, wherein when overlooking the second surface of the second substrate, the recessed structure is disposed near to a side of the second substrate, and the recessed structure is comb-shaped with an opening facing backwards to the side.

5. The substrate assembly as recited in claim 1, wherein the first substrate further comprises a fourth surface and an element layer, and the element layer is disposed on the fourth surface of the first substrate.

6. The substrate assembly as recited in claim 1, wherein the enclosed spaces are formed of rough surface structures of the first surface and the second surface.

7. The substrate assembly as recited in claim 6, wherein an average surface roughness of the first surface of the first substrate and an average surface roughness of the second surface of the second substrate are less than 300 nm.

8. The substrate assembly as recited in claim 1, wherein a material of the first substrate is glass, silicon, plastic, or metal, and a thickness of the first substrate is less than 0.3 mm.

9. The substrate assembly as recited in claim 1, wherein a material of the second substrate is glass, silicon, metal, plastic, or Teflon.

10. A method for separating a substrate assembly comprising:
providing a substrate assembly, wherein the substrate assembly comprises a first substrate and a second substrate, the second substrate has at least one through hole, and the through hole exposes the first substrate when the first substrate and the second substrate are adhered together; and
injecting a fluid through the through hole so as to separate first substrate from the second substrate.

11. The method for separating a substrate assembly as recited in claim 10, wherein a thickness of the first substrate is less than 0.3 mm.

12. The method for separating a substrate assembly as recited in claim 10, wherein an average surface roughness of the first substrate is less than 300 nm.

13. The method for separating a substrate assembly as recited in claim 10, wherein when the first substrate and the second substrate are adhered together, the first substrate and the second substrate are substantially in direct contact.

14. The method for separating a substrate assembly as recited in claim 10, wherein the fluid comprises liquid, gas or a combination thereof.

15. The method for separating a substrate assembly as recited in claim 10, wherein an element layer is formed at a surface of the first substrate away from the second substrate.

16. The method for separating a substrate assembly as recited in claim 15, wherein the element layer comprises at least one insulating material layer, at least one conductive material layer or a combination thereof.

17. The method for separating a substrate assembly as recited in claim 10, wherein the second substrate further has a recessed structure, the through hole connects through the recessed structure, and when the fluid passes through the through hole, the fluid is injected into the recessed structure so as to separate the first substrate from the second substrate.

18. The method for separating a substrate assembly as recited in claim 10, wherein after the fluid is injected through the through hole and partially separated the first substrate and the second substrate, another fluid is injected at a location of partial separation so as to completely separate the first substrate from the second substrate, and the another fluid comprises liquid, gas or a combination thereof.

19. The method for separating a substrate assembly as recited in claim 10, further comprises inserting an object at adhering surfaces of the first substrate and the second substrate during injecting a fluid through the through hole so as to separate the first substrate form the second substrate.

20. The method for separating a substrate assembly as recited in claim 19, wherein the object is a thread or a sheet.
